(19) United States
(12) Patent Application Publication
(10) Pub. No.: US 2021/0256845 A1
(43) Pub. Date: Aug. 19, 2021

(54) DRONE FORMATION FOR TRAFFIC COORDINATION AND CONTROL

(71) Applicant: International Business Machines Corporation, Armonk, NY (US)

(72) Inventors: Gil SHARON, Haifa (IL); Nili GUY, Haifa (IL)

(21) Appl. No.: 16/792,345

(22) Filed: Feb. 17, 2020

(51) Int. Cl. G08G 1/09; B64C 39/02; G08G 5/00

(52) U.S. Cl. CPC G08G 1/09; B64C 39/024; B64C 2201/143; G08G 5/0043; G08G 5/003

(57) ABSTRACT

We describe a method for training, inferencing, and a system, for controlling a swarm of unmanned aerial vehicles (UAV). The method comprises introducing a plurality of real time, past and/or simulated records documenting a plurality of sensor readings generated based on measurements taken at a region associated with an emergency event to a system. The system comprises at least one processor adapted to execute code and at least one memory storing a machine learning based model. The system produces code instructions for controlling a plurality of UAVs for presenting at the region a plurality of visual navigation instructions.

### BACKGROUND

The present invention, in some embodiments thereof, relates to emergency occurrence management and, more particularly, but not exclusively, to traffic navigation in and/or around area effected by one or more emergency occurrences such as severe car accidents, fires, and floods.

Police, other security personnel, or volunteers go to junctions or other points effected by an emergency, as soon as possible, and direct people to safer and/or less congested area, using portable lane control lights, signs, gestures or amplified voice.

### SUMMARY

According to a first aspect of the present invention there is provided a system for controlling a swarm of unmanned aerial vehicles (UAV). The system comprising one or more memories storing a machine learning based model and a code and a processor adapted to execute the code for receiving a plurality of real time records documenting a plurality of sensor readings generated based on measurements taken at a region associated with an emergency event, and feeding the plurality of real time records to the machine learning based model for producing code instructions for controlling a plurality of UAVs for presenting at the region a plurality of visual navigation instructions.

According to a second aspect of the present invention there is provided a computer implemented method of training a management system for controlling a swarm of unmanned aerial vehicles (UAV), comprising:
initializing a machine learning based model, comprising a plurality of parameters.
receiving a plurality of records documenting a plurality of sensor readings generated based on measurements taken at a region associated with an emergency event.
feeding the plurality of records to the machine learning based model for producing code instructions for controlling a plurality of UAVs for presenting to a plurality of travelers at the region a plurality of visual navigation instructions.
adapting/adjusting a plurality of parameters in the machine learning based model associated with the code instructions for controlling a plurality of UAVs produced by the machine learning based model to compliance with one or more quality criteria.

According to a third aspect of the present invention there is provided a computer implemented machine learning method for controlling a swarm of unmanned aerial vehicles (UAV), the method comprising:

receiving a plurality of real time records documenting a plurality of sensor readings generated based on measurements taken at a region associated with an emergency event.
feeding the plurality of real time records to the machine learning based model for producing code instructions for controlling a plurality of UAVs for presenting to a plurality of travelers at the region a plurality of visual navigation instructions.

In a further implementation form of the first, second and/or third aspects, the visual navigation instructions are displayed by placing the UAV swarm in a formation associated with a road sign symbol.

In a further implementation form of the first, second and/or third aspects, the presenting comprises warnings associated with approaching a dangerous area.

In a further implementation form of the first, second and/or third aspects, the formation is directed to a geographic point associated with one or more members of a group comprising roads, highways, lanes, paths, streets, sidewalks, avenues, routes, tracks, and trails.

In a further implementation form of the first, second and/or third aspects, the machine learning based model comprises a neural network.

In a further implementation form of the first, second and/or third aspects, sensor readings comprise indications associated with traffic loads.

In a further implementation form of the first, second and/or third aspects, the instructions for controlling a plurality of UAVs also comprise operation instruction for one or more sensors installed one or more of the swarm UAVs, the sensor is a member of a group comprising cameras, microphones, thermometers, humidity meters, pollutant concentration meters, anemometers, radar, LIDAR, SAR, and electromagnetic sensors.

In a further implementation form of the first, second and/or third aspects, the plurality of real time records also comprise data from one or more members of a group comprising police stations, fire departments, rescuers, ambulance dispatch centers, hospitals, weather services, monitoring stations, and traffic control centers.

In a further implementation form of the first, second and/or third aspects, the instructions for controlling a plurality of UAVs also comprise instructions to move one or more UAVs to a location and transmit data from one or more sensors.

In a further implementation form of the first, second and/or third aspects, the instructions for controlling a plurality of UAVs also comprise operation instructions for one or more members of a group comprising loudspeakers, banners, signs, screens, and light projectors.

In a further implementation form of the first, second and/or third aspects, the machine learning based model comprises a neural network.

In a further implementation form of the first, second and/or third aspects, the training of the machine learning based model is aided by an additional neural network.

In a further implementation form of the first, second and/or third aspects, the plurality of records comprises data obtained from simulations.

In a further implementation form of the first, second and/or third aspects, the plurality of records comprises data obtained from drills.

In a further implementation form of the first, second and/or third aspects, the visual navigation instructions are displayed by placing the UAV swarm in a formation associated with a road sign symbol.

In a further implementation form of the first, second and/or third aspects, wherein the presenting comprises warnings associated with approaching a dangerous area.

In a further implementation form of the first, second and/or third aspects, the formation is directed to a geographic point associated with one or more members of a group comprising roads, highways, lanes, paths, streets, sidewalks, avenues, routes, tracks, and trails.

In a further implementation form of the first, second and/or third aspects, the machine learning based model comprises a neural network.

In a further implementation form of the first, second and/or third aspects, sensor readings comprise indications associated with traffic loads.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for controlling a swarm of unmanned aerial vehicles (UAV), presenting navigating instructions at a region associated with an emergency event, according to some embodiments of the present invention;

FIG. 2A is a basic flow chart of a first exemplary process for controlling a swarm of unmanned aerial vehicles, presenting navigating instructions at a region associated with an emergency event, according to some embodiments of the present invention;

FIG. 2B is a basic flow chart of a second exemplary process for controlling a swarm of unmanned aerial vehicles, presenting navigating instructions at a region associated with an emergency event, according to some embodiments of the present invention;

FIG. 3A is a schematic, aerial view, illustration of a first exemplary presentation of navigating instructions, at a region associated with an emergency event, by a system for controlling a swarm of unmanned aerial vehicles, according to some embodiments of the present invention;

FIG. 3B is a schematic, aerial view, illustration of a second exemplary presentation of navigating instructions, at a region associated with an emergency event, by a system for controlling a swarm of unmanned aerial vehicles, according to some embodiments of the present invention;

FIG. 4 is a sequence diagram of an exemplary process for controlling a swarm of unmanned aerial vehicles, presenting navigating instructions at a region associated with an emergency event, according to some embodiments of the present invention; and

FIG. 5 is a diagram for an exemplary computer implemented method of training of a management system for controlling a swarm of unmanned aerial vehicles, according to some embodiments of the present invention.

### DETAILED DESCRIPTION

The present invention, in some embodiments thereof, relates to emergency occurrence management and, more particularly, but not exclusively, to traffic navigation in and/or around area effected by one or more emergency occurrences.

According to some embodiments of the present invention, there are provided methods, systems and computer program products for controlling a swarm of unmanned aerial vehicles, presenting navigating instructions at a region associated with an emergency event.

Shortcomings of common, known practices of presenting navigating instructions at a region associated with an emergency event, include exposing the security personnel to dangers, the costs involved, and the longer arrival time, as the emergency and resultant gridlocks may exacerbate and incur casualties by that time.

Some embodiments of the present invention involve automatically sending an unmanned aerial vehicle (UAV) or swarms thereof to the area of the occurrence, and automatically controlling them. They may use sensors, such as cameras or thermometers, to provide additional information to the control center, and present navigating instructions using formations, voice, or banners.

Some embodiments of the present invention apply a machine learning based model, trained using training data obtained from simulations, drills, and/or real emergency events for that purpose.

According to some embodiments of the present invention, data gathered by UAV sensors may be used to further better the response of the UAV on which the sensors are installed, or other UAVs. This may be obtained either automatically by a machine learning model, manually by security personnel, or by combination thereof. Additionally, the ability to observe the occurrence from many different angels, including otherwise unreachable points of view, and analyze the situation using these observations, may help control center personnel direct emergency services such as firefighters or paramedics for better effectiveness and safety.

According to some embodiments of the present invention, UAVs may present navigating instructions to drivers and pedestrians close to the occurrence, for example, by forming shapes such as arrows or stop signs, by voicing instruction through loudspeakers, or by carrying signs or banners. Furthermore, UAVs may be sent to roads, junctions etc. from which drivers or pedestrians, unaware of the occurrence may approach the dangerous area and warn them, saving time and possibly lives.

Benefits of some embodiments of the present invention include quicker arrival to the area of the occurrence, lesser need to involve control center personnel whose response times may be slower, and no need to place personnel in a dangerous area for the purpose of traffic direction. This allows many drivers and passengers who would otherwise be subject to significant delays and potential dangers to steer away from the area effected by the occurrence.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

Referring now to the drawings.

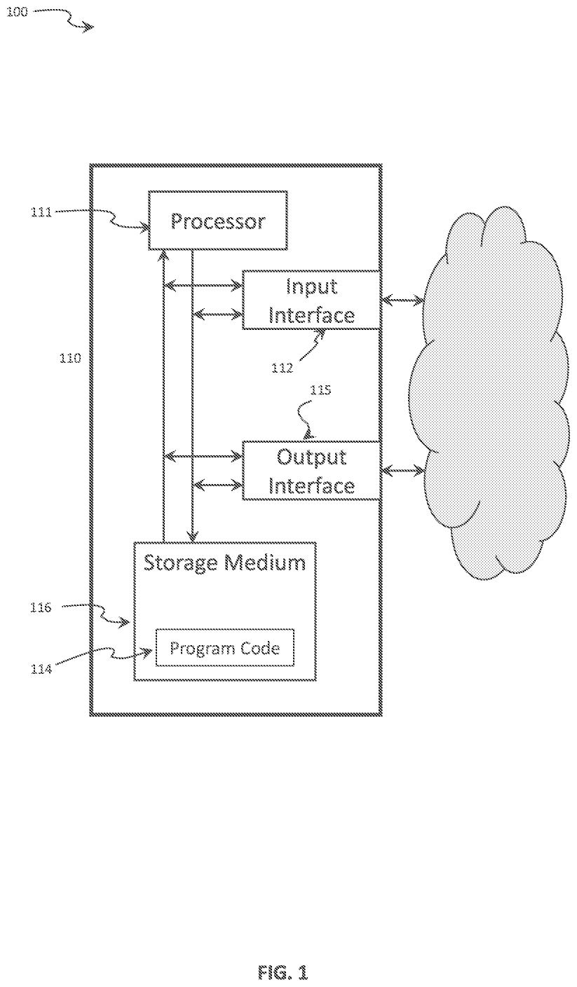

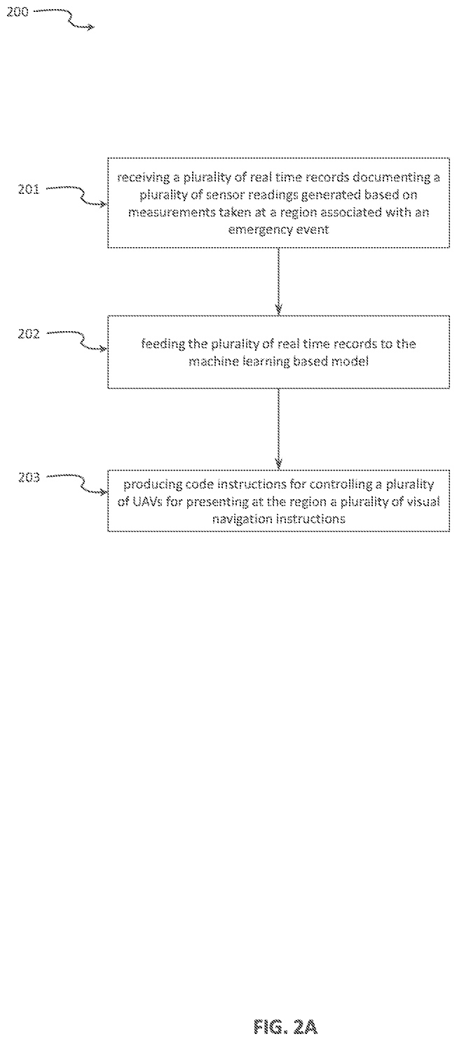

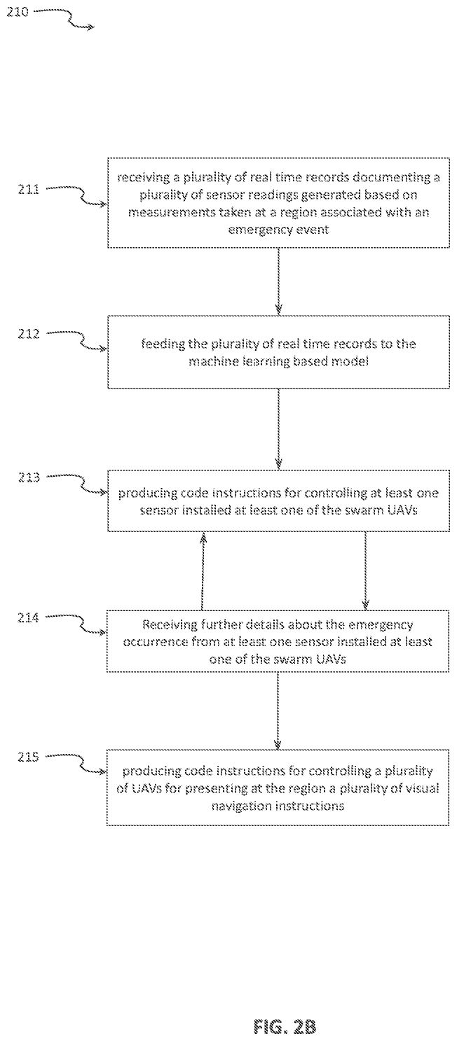

FIG. 1 is a schematic illustration of an exemplary system for controlling a swarm of unmanned aerial vehicles, according to some embodiments of the present invention. An exemplary emergency associated UAV control system 110 may execute processes such as 200 and/or 210 to generate instructions to one or more UAV swarms. Further details about these exemplary processes follow as FIG. 2A and FIG. 2B are described.

The UAV control system 110 may include an input interface 112, an output interface 115, one or more processors 111 for executing processes such as 200 and/or 210, and storage 116 for storing code (program code storage 114) and/or data. The UAV control system may be physically located on a site such as an emergency dispatch or operation center, implemented as distributed system, implemented virtually on a cloud service, on machines also used for other functions, and/or by several options. Distributed implementation may contribute to the system durability in case some of the facilities suffer from a power shortage or other afflictions that may be associated with an emergency occurrence; however, the invention is not limited to such implementations.

The input interface 112, and the output interface 115 may comprise one or more wired and/or wireless network interfaces for connecting to one or more networks, for example, a local area network (LAN), a wide area network (WAN), a metropolitan area network, a cellular network, the internet and/or the like. Additionally, the input interface 112, and the output interface 115 may include specific means for communication with one or more police stations, fire departments, rescuers, ambulance dispatch centers, hospitals, weather services, monitoring stations, and traffic control centers or facilities.

The input interface 112, and the output interface 115 may further include one or more wired and/or wireless interconnection interfaces, for example, a universal serial bus (USB) interface, a serial port, a controller area network (CAN) bus interface and/or the like. Furthermore, the output interface 115 may include one or more wireless interfaces for controlling one or more UAVs, and the input interface 112, may include one or more wireless interfaces for receiving information from one or more UAVs. Information received from UAVs may comprise sensors information, for example, information from a camera, a video camera, a microphone, a thermometer, an humidity meter, a pollutant concentration meter, an anemometer, a radar, a LIDAR, a SAR, an electromagnetic sensor, and/or the like.

Additionally, the input interface 112, and the output interface 115 may facilitate means to transmit and receive instructions, warnings about various aspects of emergency occurrences and availability of emergency services, sensor information, and/or the like.

The one or more processors 111, homogenous or heterogeneous, may include one or more processing nodes arranged for parallel processing, as clusters and/or as one or more multi core one or more processors. The storage 116 may include one or more non-transitory persistent storage devices, for example, a hard drive, a Flash array and/or the like. The storage 116 may also include one or more volatile devices, for example, a random access memory (RAM) component and/or the like. The storage 116 may further include one or more network storage resources, for example, a storage server, a network attached storage (NAS), a network drive, and/or the like accessible via one or more networks through the input interface 112, and the output interface 115.

The one or more processors 111 may execute one or more software modules such as, for example, a process, a script, an application, an agent, a utility, a tool, an operating system (OS) and/or the like each comprising a plurality of program instructions stored in a non-transitory medium within the program code 114, which may reside on the storage medium 116. For example, the one or more processors 111 may execute a process, comprising a machine learning model, for controlling a swarm of unmanned aerial vehicles, presenting navigating instructions at a region associated with an emergency event such as 200, 210 and/or the like. This process may generate code instructions for controlling a plurality of UAVs for presenting at the region a plurality of visual navigation instructions. Furthermore, the processor may execute one or more software modules for online or offline training of or more ML models, in particular reinforcement learning models such as DQN, SARSA and/or the like, as well as one or more supervised ML models, for example, a neural network such as, for example, a decision tree, a random field, a CNN, etc., an SVM and/or the like.

The system controls a plurality of UAVs, which may be similar or different in characteristics such as speed, power, maneuverability, range, size, battery size, various aspects of durability such as endurance to heat, dust, water and/or the like. These UAVs may carry a variety of sensors, lights, loudspeakers, banners, and the like. A UAV swarm may comprise some, or all of these UAVs.

Reference is also made to FIG. 2A which illustrates an exemplary process 200 for controlling a swarm of unmanned aerial vehicles, presenting navigating instructions at a region associated with an emergency event, according to some embodiments of the present invention. The exemplary process 200 may be executed for aiding management of an emergency occurrence by, inter alia, controlling a swarm of unmanned aerial vehicles, presenting navigating instructions at a region affected by that occurrence. The process 200 may be executed by the one or more processors 111.

The process 200 may start, as shown in 201 by receiving a plurality of real time records documenting a plurality of sensor readings generated based on measurements taken at a region associated with an emergency event. In some examples, these records comprise indication from one or more surveillance cameras observing for example a junction, aerial photos indicating a fire or floods, information from satellite sensors, earthquake sensors, phone calls, and/or the like. Furthermore, these records comprise in some examples data from geographic information systems (GIS), weather data and/or the like. These time records may be accessible directly to system, or may be communicate indirectly through relays, hubs, communication centers, and/or services such as police, fire department, highway patrol, hospitals, and/or ambulance dispatch services.

As shown in 202, the process 200 may continue by feeding the plurality of real time records, received as shown in 201, to the machine learning based model. In some examples, one or more processors 111 can process semantic reports about occurrences, maps, video, images, thermometer reading, and/or the like, in order to produce code instruction for one or more UAVs. The processor may execute inter alia knowledge representation based inferences, and/or machine learning models during execution of 202. The machine learning based model may comprise one or more random fields, neural networks, Boltzmann machines, decision trees, support vector machines (SVM), regression models, and/or pattern recognition methods. Furthermore, the machine learning based model may comprise one or more implementations for one or more detection algorithms, for example, an image processing based algorithm, a computer vision based algorithm, a detection machine learning model, a classifier and/or the like. These algorithms may be adapted, configured and/or trained to (visually) detect infrastructures such as roads, bridges, tracks and buildings, features associated with emergency occurrences such as fire, floods, chasms formed by earthquakes, and road users comprising vehicles, as well as people. Inferences made by one or more detection algorithms enable inter alia inferring where dangerous or congested routes are, and/or where are pedestrians, riders and/or drivers who may be at risk are.

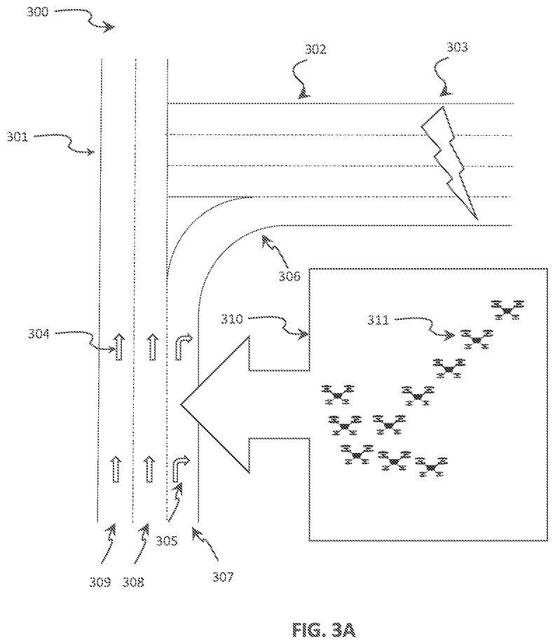

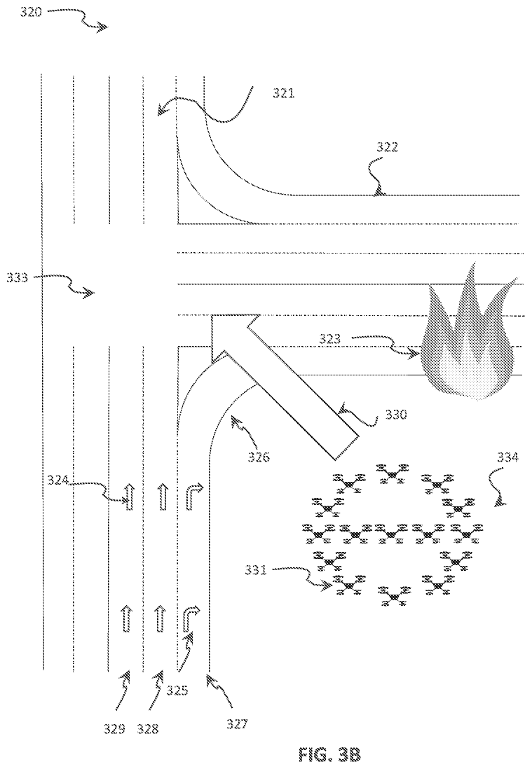

And subsequently, as shown in 203, the process 200 may continue by using the machine learning based model, executed by one or more processors 111, for producing code instructions associated to the real time record it received at 202. These instructions may be sent through the output interface 105, for controlling a plurality of UAVs for presenting at the region a plurality of visual navigation instructions, to help mitigate emergency occurrences effects. In some implementations, these instructions may be transmitted directly to UAVs through radio frequency (RF) methods, through higher frequencies such as microwaves, or infra-red (IR), directly or indirectly through relays, some of which may be closer to areas associated with one or more emergency occurrences. These instructions may comprise forming one or more formations at specified locations. Examples for these formations follow as Figures FIG. 3A and FIG. 3B described.

Reference is also made to FIG. 2B which is a basic flow chart of a second exemplary process for controlling a swarm of unmanned aerial vehicles, presenting navigating instructions at a region associated with an emergency event, according to some embodiments of the present invention. Another exemplary process 210 may be executed for aiding management of an emergency occurrence by, inter alia, controlling a swarm of unmanned aerial vehicles, collecting information otherwise difficult to obtain by flying over a region affected by that occurrence, and presenting navigating instructions at that region, and or another region affected by that occurrence. The process may be executed by the one or more processors 111.

The process 210 may start, as shown in 211, and 212 similarly to process 200 as shown in 201 and 202. Subsequently, as shown in 213, the process 210 may continue by producing code instructions generated by the machine learning model, for controlling one or more sensors installed on one or more of the swarm UAVs. These instructions may comprise instructions to move one or more locations associated with the emergency occurrence and collect further details from one or more sensors. In some examples, a camera-based traffic monitoring facility may indicate congestion in a certain road segment, yet the preferred depends on whether the congestion is caused by an accident on that road, or whether the following exit is congested. Therefore, the code instructions generated by the machine learning based model may instruct one or move UAVs to be dispatched and to take images of the road ahead, which may be used to determine the congestion cause, and thus the appropriate response.

Some of these further details about the emergency occurrence, as shown in 214, may be transmitted back to the system. Some of these further details may be fed to the machine learning model in order to produce further code instructions for one or more of the swarm UAVs. These instructions may comprise instructions to further move to one or more locations associated with the emergency occurrence and collect further details from one or more sensors, as shown in 213, and/or instructions for controlling a plurality of UAVs for presenting at the region a plurality of visual navigation instructions, as shown in 215 and similarly to 203. In another example, a water level sensor detects a flood and the preferred response depends of whether the flood results from heavy rains, dam dysfunction, or a tsunami. In this example, several UAVs can be dispatched, as shown in 213, to further explore the area and transmit images to the control system, as shown in 214, until the cause can be inferred in adequate confidence. After the system receives the images, it produces and transmits further code instruction to one or more UAVs, as shown in 215. For example, it may direct traffic away from a river at both directions, by presenting no entry signs over roads leading thereto, if a dam dysfunction floods the river.

Reference is now made to FIG. 3A which is a schematic, aerial view, illustration of a first exemplary presentation of navigating instructions, at a region associated with an emergency event, by a system for controlling a swarm of unmanned aerial vehicles, according to some embodiments of the present invention.

In the exemplary emergency occurrence associated with the exemplary formation for presenting an exemplary visual navigation instruction, a chasm 303 was formed on a road 302. Traffic from road 301 turning right at the exemplary ramp 306 to road 302 may exacerbate the traffic jam and delay the evacuation of road 302. Therefore, the system for controlling a swarm of unmanned aerial vehicles 110 sends through the output interface 115, as shown in 203, a swarm of UAVs to form a down left arrow above the lane 307. Lane 307 as indicated by arrows painted on lane such as 305 and may be seen in the figure, directs to the ramp 306, turning right. The arrow presented above the lane, may be seen a fair distance from the ramp, and allows drivers on lane 307 to move left to lane 308 or 309, directed to move forward as indicated by the arrows painted on lanes such as 304, while minimizing the danger.

The formation 310 over the lane 307 is shown magnified compared to other parts of the illustration or the sake of clarity. One or more drones 311 form the arrow. In the non-limiting example depicted herein, the arrow is six drones long and a single drone wide, and two additional drones comprise two edges, however the arrow may be shorter, longer, thicker throughout its length or at parts, comprise curved lines, and/or the like. The formation may be placed at any height above the lane, however an overly high location such as 120 meters may be hard for drives to associate with a specific lane, and placement at heights below 5 meters involves risk of collisions with some vehicles. In some examples, the drone heights may range from 4 meters to 8 meters above the lane. In other examples, the drone heights may range, for example, from 5 meters to 7 meters above the lane. In other examples, the drone heights may range, for example, from 12 meters to 18 meters above the lane. Furthermore, such formations may be also formed over geographic point associated with, paths, streets, sidewalks, avenues, routes, tracks, and trails.

Reference is also made to FIG. 3B which is a schematic, aerial view, illustration of a second exemplary presentation of navigating instructions, at a region associated with an emergency event, by a system for controlling a swarm of unmanned aerial vehicles, according to some embodiments of the present invention.

In the exemplary emergency occurrence associated with the exemplary formation for presenting an exemplary visual navigation instruction, the fire 323 is dangerously close to the road 322. Traffic from road 321 turning right at 326 to road 302, or left at the junction 333 from the other direction is at risk and may exacerbate the risk of road users already on the road 322. Therefore, the system for controlling a swarm of unmanned aerial vehicles 110 sends through the output interface 115, as shown in 203, a swarm of UAVs to form a no entry sign above the entrance to road 322 from the junction 333.

The formation 336 over the road 322 is shown magnified compared to other parts of the illustration or the sake of clarity. The arrow 330 points at an exemplary location. One or more drones 331 form a circle. In the non-limiting example depicted herein, the circle comprises twelve drones, and three additional drones comprise a horizontal stripe of one drone thickness, however the stripe as well as the circle, may be shorter, longer, thicker throughout its length or at parts, and/or the like. Furthermore, the formation may apply a plurality of circles and or horizontal stripes. The formation may be placed at any height above the lane, however an overly high location such as 300 meters may be hard for drives to associate with a specific road and may be hidden by clouds. Furthermore, a placement at heights below 5 meters involves risk of collisions with some vehicles. In some examples, the drone heights may range from 4 meters to 8 meters above the lane. In other examples, the drone heights may range, for example, from 5 meters to 7 meters above the lane. In other examples, the drone heights may range, for example, from 12 meters to 18 meters above the lane. Furthermore, other formations, for example, resembling the sign ‘X’ a text message, or other road signs may be used to warn drivers, riders, or other road users and/or direct them.

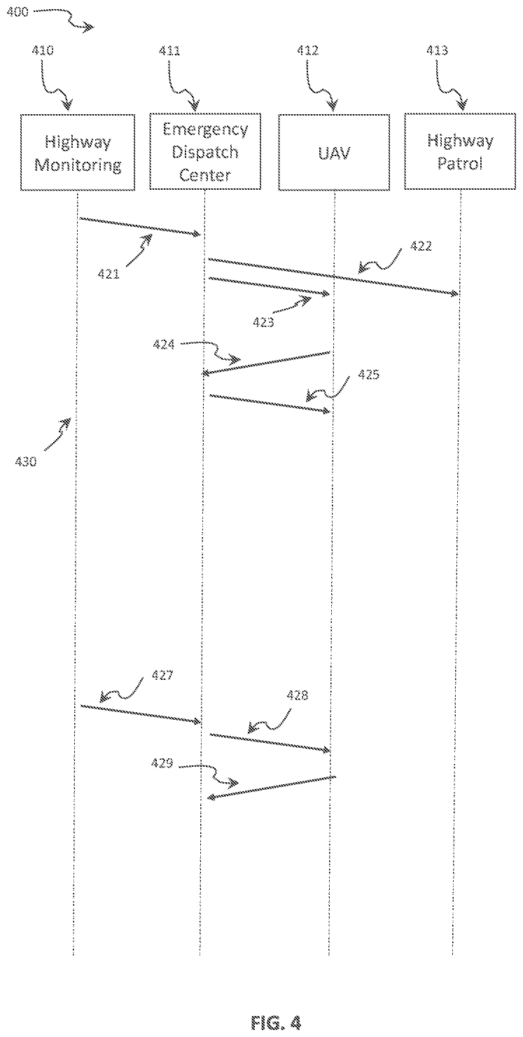

Reference is also made to FIG. 4, which is a sequence diagram of an exemplary process for controlling a swarm of unmanned aerial vehicles, presenting navigating instructions at a region associated with an emergency event, according to some embodiments of the present invention.

The exemplary sequence diagram 400 exemplifies a sequence of communication associated with a process such as 210. According to some emergency occurrences and some implementations of a system for controlling a swarm of unmanned aerial vehicles (UAV), located at an emergency dispatch center 411. The sequence diagram includes communication with a highway monitoring station 410, connected to the input interface 112 by a protocol, which support messaging, such as a telephone network, or an internet protocol such as UDP. An exemplary UAV 412 is also shown in the diagram. Furthermore, the output interface 115 is connected to a highway patrol dispatch center 413 through a protocol, which support messaging. The timeline is depicted for each agent such as the highway monitoring as a descending line 430.

The exemplary sequence is initiated as the highway monitoring station 410 indicates an emergency to the emergency dispatch center 411, by a message 421. This indication may result, for example, from automatic detection of a road accident generated by processing of camera data. After receiving this indication through the input interface 112, the system 110 at the emergency dispatch center 411 sends through the output interface 115 a message 422 to the highway patrol 413, and dispatches a UAV 412 to the area indicated by the highway monitoring. The UAV 412 is dispatched by a message 423 containing code instructions for controlling one or more sensor installed one or more of the swarm UAVs. These instructions may be produced from a machine learning based model, and comprise instructions to move one or more locations associated with the emergency occurrence and collect further details from one or more sensors, as shown, for example in 213.

When the UAV 412 arrives at the area indicated, it operates sensors such as cameras to collect information for example, the exact location of the accident, number of and types of vehicles involved, severity of the congestion, whether fire broke out and/or the like. The UAV transmits information such as its location, images and/or video from cameras, radars, LIDARs, SARs, and/or electromagnetic sensors, sounds, temperature readings, and/or pollutant concentration readings, to the controlling system in the emergency dispatch center 411 in a message 424, as shown, for example in 214.

The controlling system automatically interprets the information, and may send further code instructions in a message such as 425 to the UAV, as well as to other UAVs. These code instruction may either send to collect yet further details from one or more sensors and/or locations, or to present at the region one or more visual navigation instructions, for example, by placing itself in a formation with other UAVs, as shown, for example in 215. Examples for these formation are depicted on FIG. 3A and FIG. 3B.

When the highway patrol completes the mitigation of the emergency occurrence, the highway monitoring station 410 for example, may send a message 427 indicating the occurrence was successfully cleared. Following that, the control system in the emergency dispatch center 411 may send a message 428 instructing the drone to return. The drone may send back a message 429, which may comprise further information that may be used for debriefing, and further training for the machine learning model.

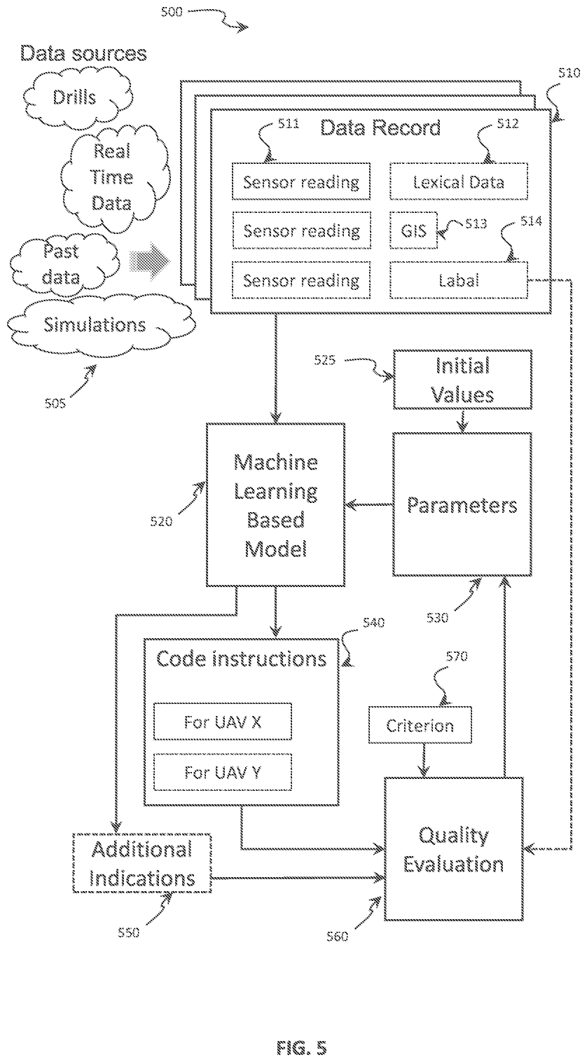

Reference is also made to FIG. 5, which is a diagram of an exemplary computer implemented method of training of a management system for controlling a swarm of UAVs, according to some embodiments of the present invention. Some embodiments of the present invention apply a machine learning based model, trained using training data obtained from simulations, drills, and/or real emergency events for that purpose.

In some implementation, a pre trained machine-learning model may be loaded to the UAV control system 110, determining the architecture of the machine learning based model 520 and its parameters 530. In some implementations, the system 110 initializes a machine learning based model, setting the parameters 530 to a random, pseudorandom, or some given set of initial values 525. In some implementations, the system 110 performs training, the training can be performed either before the system is operated, using data records based on data sources 505 such as historical data, simulations and/or drills. I some implementations, the machine learning based model is, additionally or from the start, trained online using data from actual emergency occurrences and possibly debriefing done thereafter, and/or further simulations and/or drills. The training may be facilitated manually by operators and/or other professionals, or automatically, to further improve the expected effectiveness of future responses, or other success criteria. Inference can be applied on drills, simulation, and/or historical data for testing.

The training of the machine learning based model 520 comprises receiving a plurality of records based on measurements taken at a region associated with an emergency event. Data used for training may comprise sensor readings 511, for example, weather conditions, information from satellite sensors, images or videos obtained by one or more UAVs, information from traffic control centers or directly form cameras.

The training data may also comprise data from Geographic Information Systems (GIS) 513, such as location of roads, rivers, bridges, buildings, plantation, and the like. The training data may also comprise further comprise lexical information 512, for example instruction from traffic control centers, instructions for UAVs manually prewritten by emergency professionals and/or instructions from control centers such as police, fire department, rescuers, ambulance dispatch centers, and hospitals.

The machine learning based model 520, after receiving one or more data records, by using the parameters 530, may produce associated code instruction for controlling a plurality of UAVs 540, and may produce additional indications 550 such as directives to police, fire department, rescuers, ambulance dispatch centers, and the like.

Training methods can comprise methods of supervised learning, where a scenario comprising information such as above together with a desirable response label 514 annotated into the training set by trained professionals such as police officers, fire fighters, highway patrol officer, paramedics, and/or the like. Additionally, simulation, or another machine learning or a neural network model, can be programmed or trained to provide quality evaluation 560 for responses suggested by the machine learning model.

Quality evaluation 560 estimates the effectiveness of the actions performed and formation displayed by the UAVs and evaluates the code instructions 540 produced by the machine learning based model, as well as other indications 550, in accordance with one or more quality criteria. In some implementations, the quality evaluation 560 comprises another machine learning model, for example, a neural network, a Boltzmann machine, a decision tree, an SVM, a random field and/or a regression model. A quality criterion 570 may be associated with promptness and relevance of navigation instructions displayed, minimizing causalities, minimizing delays, effects on efficiency of rescuers, minimizing environmental footprint, and/or the like. Furthermore, the quality evaluation may compare the code instructions 540 and additional indications 550 produced by the machine learning based model to the associated labels 514. Indications from the quality evaluation 560 are used for adapting and/or adjusting parameters in 530, used by the machine learning based model. Gradient descent is an example of an algorithm used from these parameter adjustments.

It is expected that during the life of a patent maturing from this application many relevant machine learning methods, manned and/or unmanned vehicles and means of communication therewith, transportation infrastructure facilities such as roads, and/or emergency management capabilities of police, rescuers, fire departments, ambulance and medical services will be developed and the scope of the terms used herein is intended to include all such new technologies a priori.

The terms “comprises”, “comprising”, “includes”, “including”, “having” and their conjugates mean “including but not limited to”.

As used herein, the singular form “a”, “an” and “the” include plural references unless the context clearly dictates otherwise. For example, the term “a UAV” or “one or more UAVs” may include a plurality of UAVs, including UAVs of different types.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Furthermore, it should be understood that the description in numerical format is merely for convenience and brevity and should not be construed as an inflexible limitation on the scope of the invention. Accordingly, the description of a numerical values should be considered to have specifically disclosed all practically interchangeable numerical values.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for controlling a swarm of unmanned aerial vehicles (UAV), the system comprising:
at least one memory storing a machine learning based model and a code; and
a processor adapted to execute the code for:
receiving a plurality of real time records documenting a plurality of sensor readings generated based on measurements taken at a region associated with an emergency event; and
feeding the plurality of real time records to the machine learning based model for producing code instructions for controlling a plurality of UAVs for presenting at the region a plurality of visual navigation instructions.

2. The system of claim 1, wherein the visual navigation instructions are displayed by placing the UAV swarm in a formation associated with a road sign symbol.

3. The system of claim 2, wherein the formation is directed to a geographic point associated with at least one member of a group comprising roads, highways, lanes, paths, streets, sidewalks, avenues, routes, tracks, and trails.

4. The system of claim 1, wherein the instructions for controlling a plurality of UAVs also comprise operation instruction for at least one sensor installed at least one of the swarm UAVs, the sensor is a member of a group comprising cameras, microphones, thermometers, humidity meters, pollutant concentration meters, anemometers, radar, LIDAR, SAR, and electromagnetic sensors.

5. The system of claim 1, wherein the plurality of real time records also comprise data from at least one member of a group comprising police stations, fire departments, rescuers, ambulance dispatch centers, hospitals, weather services, monitoring stations, and traffic control centers.

6. The system of claim 1, wherein the instructions for controlling a plurality of UAVs also comprise instructions to move at least one UAV to a location and transmit data from at least one sensor.

7. The system of claim 1, wherein the instructions for controlling a plurality of UAVs also comprise operation instructions for at least one member of a group comprising loudspeakers, banners, signs, screens, and light projectors.

8. A computer implemented method of training a management system for controlling a swarm of unmanned aerial vehicles (UAV), comprising:
initializing a machine learning based model, comprising a plurality of parameters;
receiving a plurality of records documenting a plurality of sensor readings generated based on measurements taken at a region associated with an emergency event;
feeding the plurality of records to the machine learning based model for producing code instructions for controlling a plurality of UAVs for presenting to a plurality of travelers at the region a plurality of visual navigation instructions; and
adapting/adjusting a plurality of parameters in the machine learning based model associated with the code instructions for controlling a plurality of UAVs produced by the machine learning based model to compliance with at least one quality criterion.

9. The method of claim 8, wherein the machine learning based model comprises a neural network.

10. The method of claim 9, wherein the training of the machine learning based model is aided by an additional neural network.

11. The method of claim 8, wherein the plurality of records comprises data obtained from simulations.

12. The method of claim 8, wherein the plurality of records comprises data obtained from drills.

13. The method of claim 8, wherein the visual navigation instructions are displayed by placing the UAV swarm in a formation associated with a road sign symbol.

14. The method of claim 13, wherein the formation is directed to a geographic point associated with at least one member of a group comprising roads, highways, lanes, paths, streets, sidewalks, avenues, routes, tracks, and trails.

15. The method of claim 8, wherein sensor readings comprise indications associated with traffic loads.

16. The method of claim 8, wherein the instructions for controlling a plurality of UAVs also comprise operation instruction for at least one sensor installed at least one of the swarm UAVs, the sensor is a member of a group comprising cameras, microphones, thermometers, humidity meters, pollutant concentration meters, anemometers, radar, LIDAR, SAR, and electromagnetic sensors.

17. The method of claim 8, wherein the plurality of real time records also comprise data from at least one member of a group comprising police stations, fire departments, rescuers, ambulance dispatch centers, hospitals, weather services, monitoring stations, and traffic control centers.

18. The method of claim 8, wherein the instructions for controlling a plurality of UAVs also comprise instructions to move at least one UAV to a location and transmit data from at least one sensor.

19. The method of claim 8, wherein the instructions for controlling a plurality of UAVs also comprise operation instructions for at least one member of a group comprising loudspeakers, banners, signs, screens, and light projectors.

20. A computer implemented machine learning method for controlling a swarm of unmanned aerial vehicles (UAV), the method comprising:
receiving a plurality of real time records documenting a plurality of sensor readings generated based on measurements taken at a region associated with an emergency event; and
feeding the plurality of real time records to the machine learning based model for producing code instructions for controlling a plurality of UAVs for presenting to a plurality of travelers at the region a plurality of visual navigation instructions.
